(19) United States
(12) Patent Application Publication
(10) Pub. No.: US 2016/0155110 A1
(43) Pub. Date: Jun. 2, 2016

(54) DYNAMIC RISK ASSESSMENT AND PEER-TO-PEER TRANSACTION SYSTEM AND METHOD

(71) Applicant: GOOD TRAVEL SOFTWARE LIMITED, Dublin, 8 (IE)

(72) Inventors: Thomas Wright, London (GB); Vinay Gupta, Briarcliff Manor, NY (US)

(21) Appl. No.: 14/652,551

(22) PCT Filed: Dec. 23, 2013
(86) PCT No.: PCT/US13/77414

§ 371 Date: Jun. 16, 2015

Related U.S. Application Data
(60) Provisional application No. 61/745,697, filed on Dec. 24, 2012.

(51) Int. Cl. G06Q 20/22; G06Q 20/40; G06Q 40/08

(52) U.S. Cl. CPC G06Q 20/223; G06Q 40/08; G06Q 20/4016

(57) ABSTRACT

A system and method for booking peer-to-peer asset transactions, dynamically assessing risk associated with the transactions, and generating custom insurance policies for the transactions. A risk profile is created for the asset, an owner of the asset, and a potential renter of the asset based on data about the asset, data about the owner, and data about the potential renter, respectively. A risk analysis is performed based the risk profiles of the asset, asset owner, and potential renter, and other information, such as a duration and a location associated with the transaction. This risk analysis is used to provide an insurance premium for the transaction and generate a custom insurance policy when the transaction is booked. Payment may also be taken to complete the transaction.

### FIELD

The present disclosure relates to peer-to-peer transactions (“P-P transactions”), and more particularly to systems and methods for managing risks associated with the transactions.

### BACKGROUND

With the advancement of technology, online computer transactions and peer-to-peer (“P-P”) transactions are becoming more prevalent. For example, there are many rental car companies that offer car rental services, including booking services, online. Additionally, U.S. Patent Application Publication No. 2011/0213629, entitled CAR SHARING, describes an online website through which an owners of car and a borrower/renter can arrange a sharing transaction in which the borrower rents the car from the owner. According to U.S. Patent Application Publication No. 2011/0213629, general insurance coverage is provided that applies to the sharing transactions and covers the borrower, the owner, and the car; and the cost of the insurance is determined based on usage (liability coverage, for example, is billed by the mile, and physical damage coverage is billed by the hour).

Similarly, most rental car companies also provide the option to purchase general insurance coverage to those renting a car from them. However, these general insurance plans may not be adequate or appropriate in all situations. This can result in some renters/borrowers paying more than necessary for insurance coverage, and/or paying for excessive or inadequate insurance coverage. As is typically the case, insurance is provided by a supplier (insurance company/underwriter) to an existing business to cover a commercial exchange between the business and customer, never before to two private individuals to facilitate a risk-adjusted commercial exchange between them. Further, the systems and methods for implementing these risk management programs are not particularly robust or user-friendly.

### SUMMARY

A system and methods are disclosed for booking peer-to-peer asset transactions or rentals, and dynamic risk assessment and generation of insurance policies customized to the transaction. While the concepts of the disclosure are illustratively described in regard to a peer-to-peer car rental context, the concepts are applicable as well to peer-to-peer transactions for other assets such as home rentals/leases, financial lending or other latent asset monetization. In an illustrative embodiment, an owner of an asset, for example a vehicle, owner submits the vehicle as available for a transaction, by submitting information about the asset. In the case of a vehicle the owner may submit vehicle information such as a license plate number of the vehicle and a postal code where the vehicle is located. The system validates the owner's asset information submission by searching one or more third party databases to obtain further information. The system can generate a suggested rental price for the asset based on this data (e.g. vehicle and location information). The system may also create a risk profile for the asset/vehicle and the owner of the vehicle based on data about the vehicle and data about the owner, respectively.

A user seeking to rent the asset/vehicle submits data, for example, including his/her age, name, postal code, driver license number, and other information. The system validates the submission by searching one or more third party databases to obtain the age, name, postal code, driver license number, and other information of the user. The system may also create a risk profile for the user based on the data.

The system performs a risk analysis based on a duration, location, and/or other data associated with the rental, and the risk profiles of the vehicle, owner, and user. This risk analysis is used to provide an insurance premium for the transaction and generate an insurance policy when the transaction is booked.

Advantageously, renters and owners can be brought together and the risk profile of an individual transaction dynamically generated. Based on a computed risk profile(s) an insurance policy can be automatically generated to facilitate a risk-adjusted commercial exchange between two private individuals.

### BRIEF DESCRIPTION OF THE DRAWINGS

Embodiments of devices, systems, and methods are illustrated in the accompanying drawings which are meant to be exemplary and not limiting, in which like references are intended to refer to like or corresponding parts, and in which:

FIG. 1 illustrates an overview diagram of a system for implementing the present disclosure;

FIG. 2 overview of the system and method of booking an asset, obtaining insurance pricing and obtaining an insurance policy;

FIG. 3 illustrates a flow diagram of a system and method of receiving and publishing eligible assets;

FIG. 4 illustrates a flow diagram of a process for determining a risk profile of an asset and an owner of the asset;

FIG. 5 illustrates a flow diagram of a process for validating a qualifying user seeking to book an asset;

FIG. 6 illustrates a block diagram of a process for determining a risk profile of a user seeking to book an asset;

FIG. 7 illustrates a flow diagram of a process for booking an asset;

FIG. 8 illustrates a flow diagram of a process for notifying an owner of an asset of flagged parameters;

FIG. 9 illustrates a flow diagram of a process for presenting a user seeking to book an asset with alternate asset options; and

FIG. 10 illustrates a block diagram of a system and method of the disclosure.

### DETAILED DESCRIPTION

Detailed embodiments of devices, systems, and methods are disclosed herein, however, it is to be understood that the disclosed embodiments are merely exemplary of the devices, systems, and methods, which may be embodied in various forms. Therefore, specific functional details disclosed herein are not to be interpreted as limiting, but merely as a basis for the claims and as a representative basis for teaching one skilled in the art to variously employ the present disclosure.

Generally, the present disclosure relates to a system and methods for booking peer-to-peer asset transactions or rentals, and dynamic risk assessment and generation of insurance policies customized to the transaction. In an illustrative embodiment, an owner of a vehicle (which could readily be some other asset, such as a boat, car, airplane, home, apartment, or the like) submits the vehicle/asset as available for a transaction, for example, by submitting vehicle information such as a license plate number of the vehicle and a postal code where the vehicle is located. The system validates the owners submission by searching one or more third party databases to obtain further vehicle information such as the vehicle's age, model, and location, and can even generate a suggested rental price for the vehicle based on this data. The system may also create a risk profile for the vehicle and the owner of the vehicle based on data about the vehicle and data about the owner, respectively.

A user seeking to rent the vehicle submits data, for example, including his/her age, name, postal code, driver license number, and other information. The system validates the submission by searching one or more third party databases to obtain the age, name, location, driver license number, and other information of the user. The system may also create a risk profile for the user based on the data.

The system performs a risk analysis based on a duration, location, and/or other data associated with the rental, and the risk profiles of the asset and two transactors (e.g. vehicle, owner, and user/renter). This risk analysis is used to assign an insurance premium for the transaction and generate an insurance policy when the transaction is booked.

The system may also flag certain parameters of the user seeking to rent the vehicle and notify the owner of the flags. The owner can also set customized parameters to be flagged by the system and transmitted to the owner, for example, age, location, experience, and other parameters of the user seeking to hire the asset (e.g. in the illustrative embodiment, rent the vehicle). This provides the owner with information about the person seeking to rent his/her asset. This also provides the owner with the option to proceed with or decline to rent the vehicle to the user if the owner is uncomfortable with renting to the user.

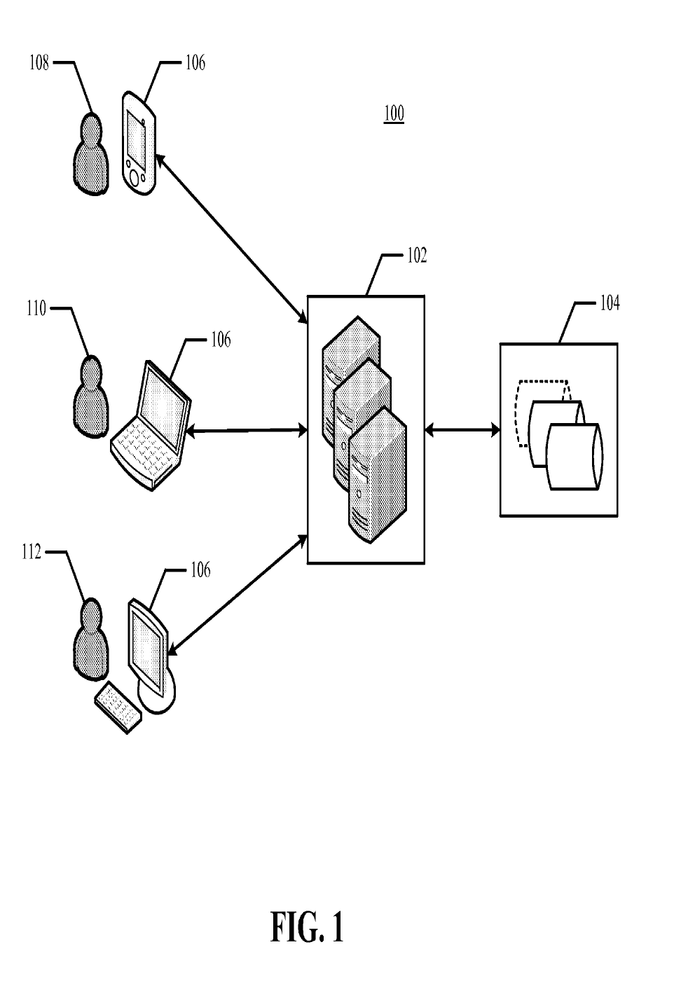

In an illustrative embodiment, the devices, systems, and methods are implemented within a client/server based computing system 100. An overview of the computing system 100 is described with reference to FIG. 1. As illustrated, the computing system 100 includes one or more computing devices 102 or data processing devices, one or more databases 104, and one or more client devices 106 operated by one or more users, for example, User A 108, User B 110, and User C 112. The one or more computing devices 102 are in communication with the one or more databases 104, for example, over a network, such as the Internet, allowing the one or more computing devices 102 to access, provide, transmit, receive, and modify information and data stored in the one or more databases 104. Similarly, the one or more computing devices 102 are in communication with the one or more client devices 106, for example, over the network, allowing the one or more computing devices 102 to access, provide, transmit, and/or receive information and data to and from the users (User A 108, User B 110, and/or User C 112) through the one or more client devices 106.

In an illustrative embodiment, the one or more computing devices 102 present a graphical user interface (GUI) to the users via the client devices 106. The users (User A 108, User B 110, and/or User C 112) can interact with the GUI to input data to and receive data from the one or more computing devices 102 to enter into and book transactions with another user.

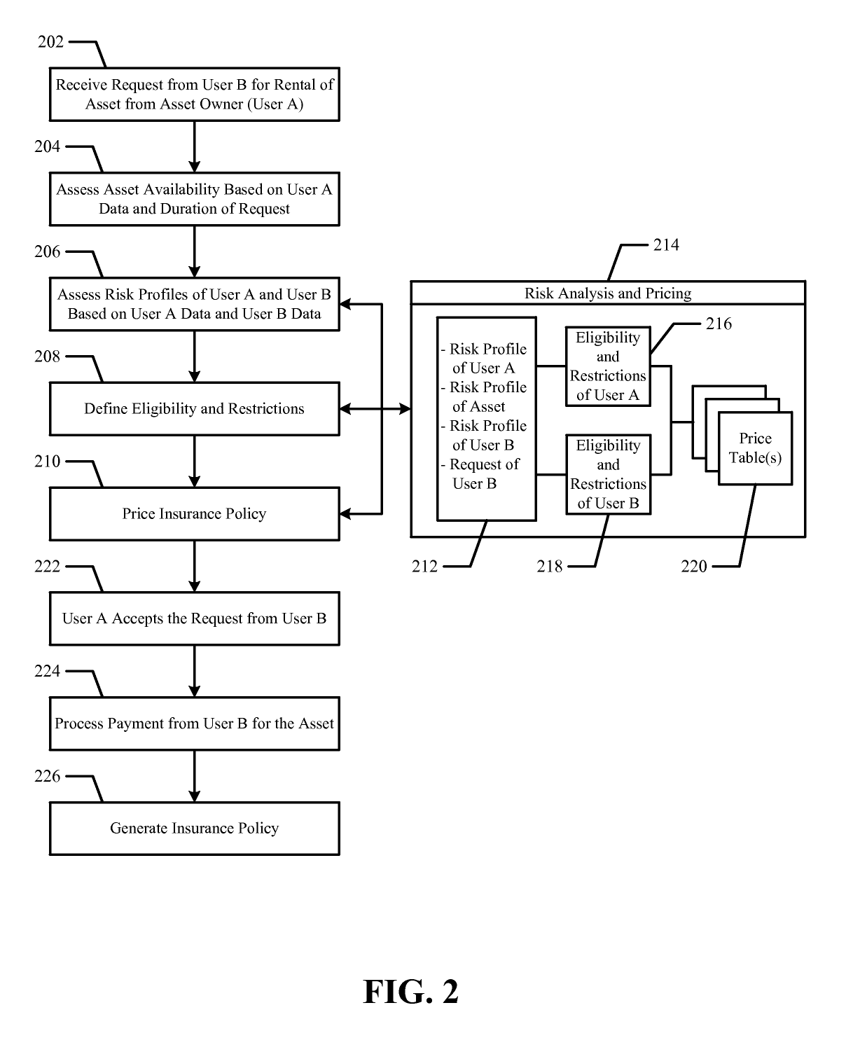

A user seeking to rent an asset (referred to hereinafter as User B) from an owner of the asset (referred to hereinafter as User A) access the GUI, for example, via the Internet, and submits a request to book the asset for rental. An overview of the system and method of booking an asset, obtaining insurance pricing and obtaining an insurance policy is described with reference to FIG. 2. The computing device(s) 102 receives 202 the request of the User B 110 to rent the asset from the User A 108. It should be appreciated that User A may have a collection of assets (one to many) so the system is capable of risk analysis and pricing of multiple assets for one user. The computing device(s) 102 assesses the asset availability 204 based on data received from User A and a rental period or duration of rental specified in the request of User B 110. If the asset is unavailable, the computing device(s) 102 may present the User B with alternate asset options; and if the asset is available for rental during the specified rental period, the computing device(s) 102 proceeds. In another embodiment, the User B may submit a broad request for an asset available during a specific rental period, and users may respond to the request or the computing device(s) 102 may present the User B with available asset options.

Assuming the asset is available, the computing device(s) 102 assesses 206 a risk profile of each of the User B, the User A, and the asset based on data corresponding to User A, User B, and the asset. Based on these risk profiles, the computing device(s) 102 defines eligibility and restrictions 208, and prices a custom insurance policy 210 tailored to the transaction between the User A and the User B for the asset. For example, the insurance premium may be different when the rental period is one (1) week versus one (1) day. Similarly, the insurance premium may be different based on the location of the rental, the individual users involved in the transaction, and/or the asset involved in the transaction.

To price the custom insurance policy, the risk profiles of the User A, the asset, the User B, and the details of the rental request 212 are analyzed 214 by the computing device(s) 102. The eligibility and the restrictions are defined 216, 218 for the User A and the User B, respectively. The computing device(s) 102 may then consult or look-up price amounts in one or more insurance policy price tables 220. These price tables may be a collection of prices associated with various insurance policies and/or companies, and the price for the custom insurance policy may be matched or estimated based on the prices of the similar insurance policies in the price tables.

After the custom insurance policy has been priced 210, the User B (renter) can pay this sum as part of their transaction cost. Alternatively, this payment might simply be held pending approval of the transaction by the User A. Here, User A would be presented with the opportunity to accept or decline 222 the request of the User B. If the User A declines the request, the computing device(s) 102 may present the User B with alternate asset options; and if the User A accepts the request, the computing device(s) 102 proceeds with the transaction. If User A accepts the request, the User B is prompted for payment for the transaction. Upon receiving payment from the User B, the payment is processed 224, and the custom insurance policy is generated 226. Payment may be effected using any known payment method or type, for example, a credit or debit card, bank account, check, electronic funds transfer, and other methods of payment.

It should be appreciated that as an alternative to the opportunity to accept or decline 222, a peer-to-peer “permission layer access” can be predefined between user A and user B negating the need for item 222 below. That is, an owner may finalize the transaction by accepting or declining, but in a further embodiment predefined restrictions on bookings that an owner would like to impose (depending upon their proclivities for risk/reward balance on any booking), and any booking placed which fits this predefined criteria may be automatically confirmed (without needing the owner to approve them).

The type of transaction being carried out can shape the eligibility and restriction criteria to be included in the risk analysis, to be imposed on the User A and the User B, and any rules for the generation of the custom insurance policy. For example, in a vehicle rental transaction described above, the eligibility and risk criteria for the User B may include, but is not limited to, location, age, driving history and identity checks of User B; and the eligibility and risk criteria for the User A and the asset may include, but is not limited to, age of vehicle, ownership and condition of vehicle, location and identity checks of User A. Additional criteria relating to the specific transaction may also be factored in to the risk analysis including, but not limited to, time/duration of the transaction, value of transaction, and the transaction history of the users involved. In one example, a restriction on the type of car made available may be based on the age of User B or the level of deposit being required to the User B who is old enough to remain eligible (e.g. over 21) but who poses a notable additional risk (e.g. below 25).

The risk profiles of the User A and the User B may result in transaction and service restrictions, for example, such limitations might include restricted access to certain asset inventory, a cap on transaction value or frequency, a limitation on payment methods, certain deposit amounts and other restrictions.

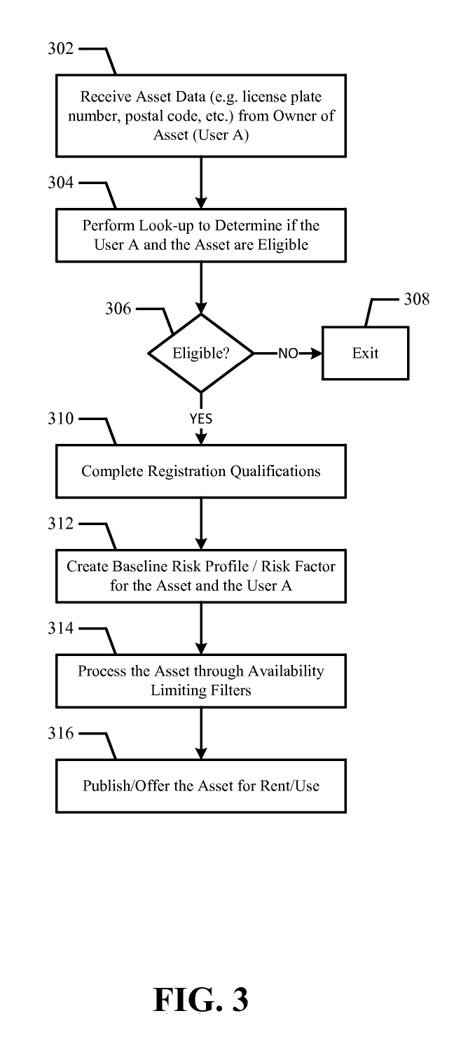

In general, prior to an asset being available to be involved in a transaction, an owner of the asset (User A) registers the asset. A system and method of registering or posting an asset is described with reference to FIG. 3. The computing device(s) 102 receive 302 data corresponding to the asset from the owner of the asset (User A). The asset data may include, for example, a license plate number, value, age, registration number, postal code of registration or location, and other information related to the asset. The computing device(s) 102 may also request and receive data corresponding to the User A, for example, including name, address, driving history and other information. The computing device(s) 102 validates the asset data and the User A data received from the User A by performing a look-up 304, for example, in third party databases, to determine if the asset and the User A are eligible. For example, the computing device(s) 102 may look-up the license plate number in a Department of Motor Vehicles (DMV), Registry of Motor Vehicle (RMV), and/or a Driver Vehicle Licensing Authority database (DVLA). Similarly, the computing device(s) 102 may look-up the postal code in a location table.

The license plate look-up may provide data such as the age of the vehicle, type of vehicle, class of insurance (e.g. commercial or non-commercial vehicle). Similarly, the postal code look-up may provide data such as the state, city, town where the vehicle is registered and located. Based on the asset data and User A data, the computing device(s) 102 determines 306 if the asset is eligible for registration. If the asset is not eligible, the computing device(s) 102 exits 308 the registration process. For example, if the vehicle is over 25 years old, the vehicle may be ineligible and rejected for eligibility, if the vehicle is located in a town with a high crime rate it may be rejected for eligibility, and/or if the vehicle does not operate it may be rejected for eligibility.

If the asset is eligible, the computing device(s) 102 completes the registration qualifications 310, for example, by requesting additional data from the User A. Based on the data received from the User A and the data obtained via third party databases, the computing device(s) 102 creates a baseline risk profile for the asset and the User A. The computing device(s) 102 may also process 314 the asset through one or more availability filters. The availability filters may limit the availability of the asset to certain locations based on the postal code of the asset, limit the duration of rental period or type of rental based on the age of the vehicle, limit the availability of the asset to potential renters holding specific types of driver licenses, and other filters of the type. Additionally, the computing device(s) 102 offers or publishes 316 the asset for rent or use, for example, on a website or to potential renters.

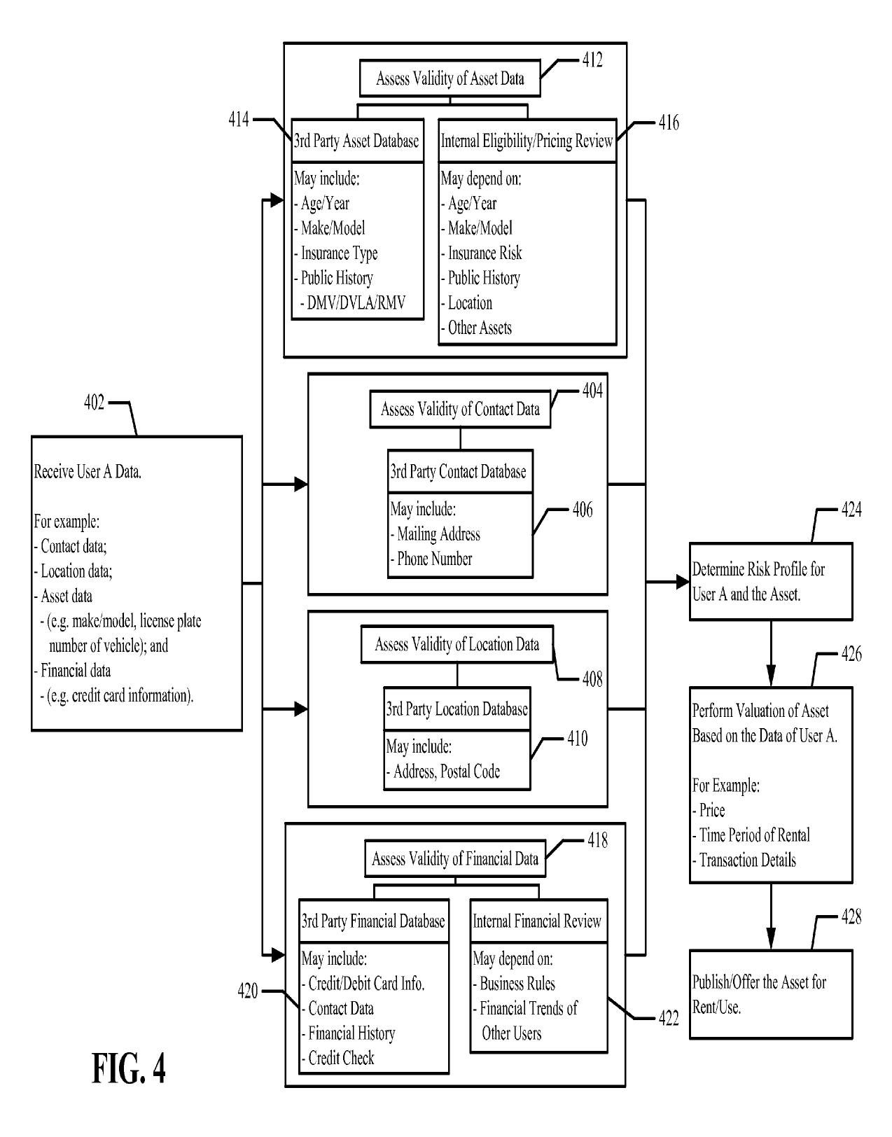

A block diagram of a system and process or method for determining a risk profile of the asset and the User A is described with reference to FIG. 4. As described above, the computing device(s) 102 receives data 402 from the User A (referred to hereinafter as User A data), including, but not limited to, contact data (e.g. name, address, telephone number, email address of the User A, and other information), location data (e.g. postal code, and other information), asset data (e.g. make and model of vehicle, license plate number, year of vehicle, and other information), financial data (e.g. credit card, bank, and other payment information), and other data relating to the User A and/or the asset.

The validity of the contact data 404 is assessed, for example by searching and/or looking-up in one or more third party databases 406 the mailing address, telephone number, and other information relating to the User A and comparing this information to the data provided by the User A. Similarly, the validity of the location data 408 is assessed, for example by searching and/or looking-up in one or more third party databases 410 the address, postal code, and/or other information of the User A and comparing this information to the data provided by the User A.

The validity of the asset data 412 is assessed, for example by searching and/or looking-up in one or more third party databases 406 the age/year of the asset, the make and model of the asset, the insurance class of the asset, any public history of the asset (e.g. found in a DMV, RMV, and/or DVLA database), and/or other information relating to the asset. This data may be compared to the data provided by the User A to validate the data provided by the User A. Additionally, the computing device(s) 102 may perform an internal eligibility and/or valuation review 416 of the asset, for example, based on the age/year of the asset, the make and model of the asset, the insurance risk of the asset, any public history of the asset, location of the asset, and/or other information relating to the asset.

The validity of the financial data 418 is assessed, for example by searching and/or looking-up in one or more third party databases 420 the credit/debit card information, contact data, financial history, credit check, and/or other information relating to the finances of the User A. This data may be compared to the data provided by the User A to validate the data provided by the User A. Additionally, the computing device(s) 102 may perform an internal financial review 422 of the User A, for example, based on financial trends of other users, business rules, and/or other information relating to the finances of the User A. In this way a members' transaction and activity history may be considered within eligibility and cost analysis. For example, a member who has negative ratings or a history of damages during rentals may have a premium assigned to their transaction or be barred from carrying out further transactions or further transactions above a certain threshold in value or duration.

Based on the contact data, location data, asset data, financial data, and the data and information obtained from third party databases, the computing device(s) 102 creates and determines one or more risk profiles 424 for the asset and the User A. A non-static weighting may be assigned here. Depending on the context in which the platform is being applied (e.g. houses versus cars) the weight of any given criteria may be weighted as most or more significant and determine how these criteria then factor in to risk analysis and pricing.

Additionally, the computing device(s) 102 may perform a valuation of the asset 426 based on the contact data, location data, asset data, financial data, and the data and information obtained from third party databases. The valuation may generate a suggested price for offering the asset for rental, and may be modified based on a transaction time period and other details of the transaction. This valuation may simply look at supply and demand within the asset area and the inherent value of the object being monetized/rented. Again it is industry/asset-specific but will factor in age, value, demand, supply and competition from comparable products from alternative services. For example, for a vehicle asset where the plate number and postcode are entered, the platform uses the former to define age, model, insurance group and car type and the latter to define demand in an area (based on recent activity in booking requests, searches and member registration in this area). These variables are mapped in a table against pricing of competitor cars in the area and similar cars on the service. These factors combine to assign a Rental Price Guidance (or RPG) valuation indicating what is believed to be the optimum pricing for the asset. Although, the computing device(s) 102 generates a suggested price, the User A may override the suggested price and charge any desired amount for rental of the asset. The asset may also be offered or posed for rental or use 428 by the computing device(s) 102.

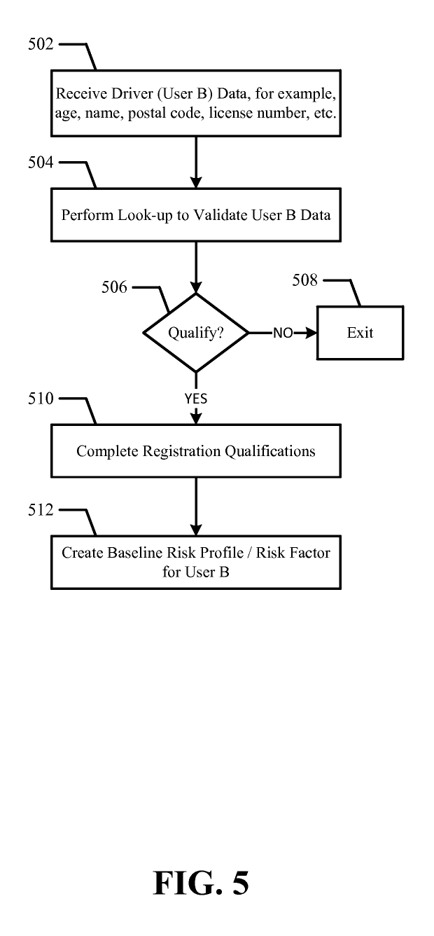

Similar to registration of the asset and the User A, the potential renter (User B) registers with the system prior to renting an asset or entering into a transaction. A process of registering the User B is described with reference to FIG. 5. The computing device(s) 102 receives 502 data corresponding to the User B. The data corresponding to the User B may include, for example, a name, address, driver license number, postal code and other information of the User B. This data may be submitted by the User B or pulled by the computing device(s) 102 from a social network site of the User B.

The computing device(s) 102 validates the data received from the User B by performing a look-up 504, for example, in third party databases, to determine if the

User B qualifies. For example, the computing device(s) 102 may look-up the name and driver license number of the User B in one or more third party databases to determine the age, driver license type, location, driving history, and other information related to the User B.

Based on the User B data, the computing device(s) 102 determines 506 if the User B qualifies for registration. If the User B is not eligible, the computing device(s) 102 exits 508 the registration process. For example, if the User B is under a certain age, the User B may be disqualified, or if the User B has been in numerous accidents, the User B may be disqualified. Various bases for disqualification may be set in the process. If the User B qualifies, the computing device(s) 102 completes the registration qualifications 510, for example, by requesting additional data from the User B. Based on the data received from the User B and the data obtained via third party databases, the computing device(s) 102 creates 512 a baseline risk profile for the User B.

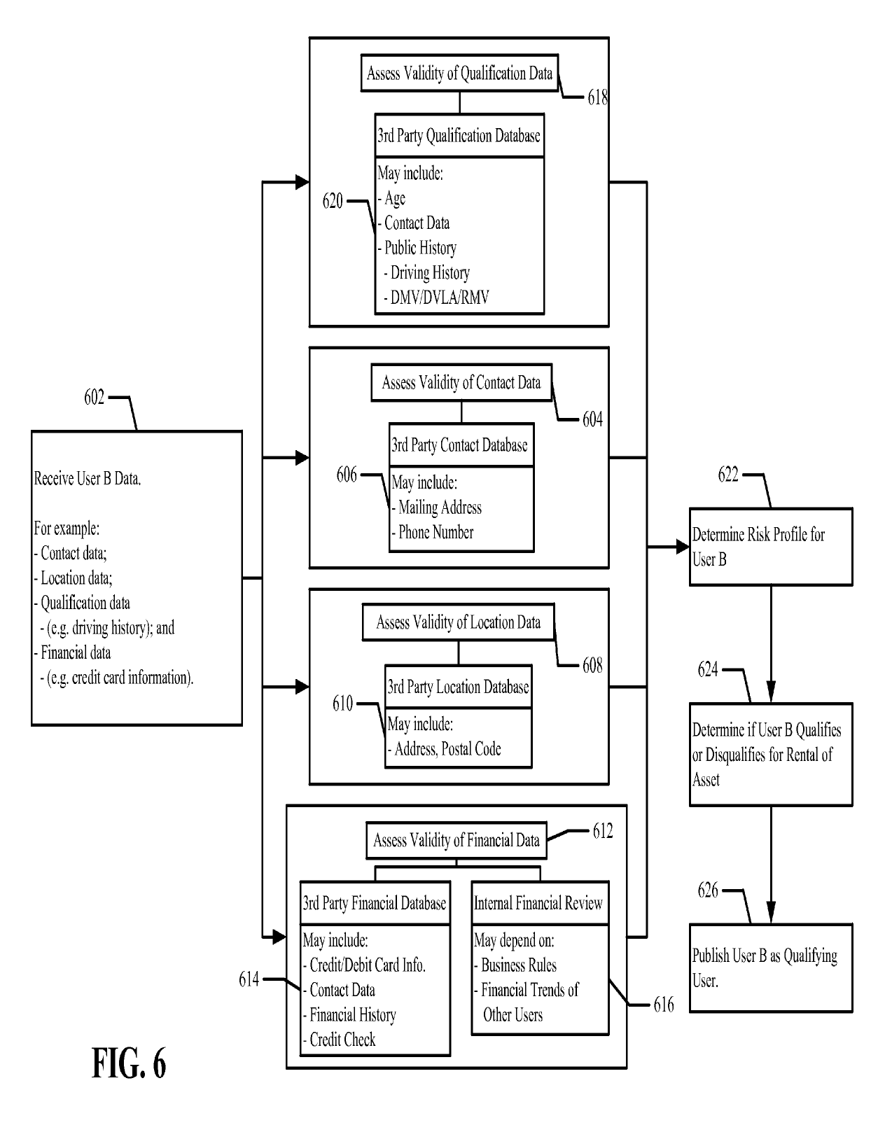

A block diagram of a process for determining a risk profile of the User B is described with reference to FIG. 6. As described above, the computing device(s) 102 receives data 602 from the User B (referred to hereinafter as User B data), including, but not limited to, contact data (e.g. name, address, telephone number, email address of the User B, and other information), location data (e.g. postal code, and other information), qualification data (e.g. age, contact data, driver license number, driving history, certifications, training, and other information), financial data (e.g. credit card, bank, and other payment information), and potentially other data relating to the User B as a function of the application.

The validity of the contact data 604 is assessed, for example by searching and/or looking-up in one or more third party databases 606 the mailing address, telephone number, and other information relating to the User B and comparing this information to the data provided by the User B. Similarly, the validity of the location data 608 is assessed, for example by searching and/or looking-up in one or more third party databases 610 the address, postal code, and/or other information of the User B and comparing this information to the data provided by the User B.

The validity of the financial data 612 is assessed, for example by searching and/or looking-up in one or more third party databases 614 the credit/debit card information, contact data, financial history, credit check, and/or other information relating to the finances of the User B, as may be appropriate for the application. This data may be compared to the data provided by the User B to validate the data provided by the User B. Additionally, the computing device(s) 102 may perform an internal financial review 616 of the User B, for example, based on financial trends of other users, business rules, and/or other information relating to the finances of the User B. For example, a user who attempts to rent an asset having provided a second set of payment details (with the first having failed security validation) may prompt an additional data set requirement.

The validity of the qualification data 618 is assessed, for example by searching and/or looking-up in one or more third party databases 620 the age, contact data, public history (e.g. found in a DMV, RMV, and/or DVLA database), and/or other information relating to the User B. This data may be compared to the data provided by the User B to validate the data provided by the User B.

Based on elements including contact data, location data, asset data, financial data, and the data and information obtained from third party databases, the computing device(s) 102 creates and determines one or more risk profiles 622 for the User B. Here the profile will be assigned a risk multiplier based on the outcome of this analysis where, for example, a low-risk member will be given a 0.7 risk analysis versus a high risk member being given, for example a 1.3 rating. These multipliers will be used to define risk premium calculations when mapped with the corresponding asset, duration and member risk.

Additionally, the computing device(s) 102 may perform a qualification check 624 based on the contact data, location data, qualification data, financial data, and the data and information obtained from third party databases. The qualification check may determine one or more restrictions that may be placed on the User B's ability to enter into certain transactions. For example, the User B may be restricted from entering into transactions for certain assets based on lack of experience with such assets, based on the User B′ age, based on User B's class of driver license, and/or other information. After obtaining the User B data, the User B may be posted, published, or allowed to enter into transactions 626.

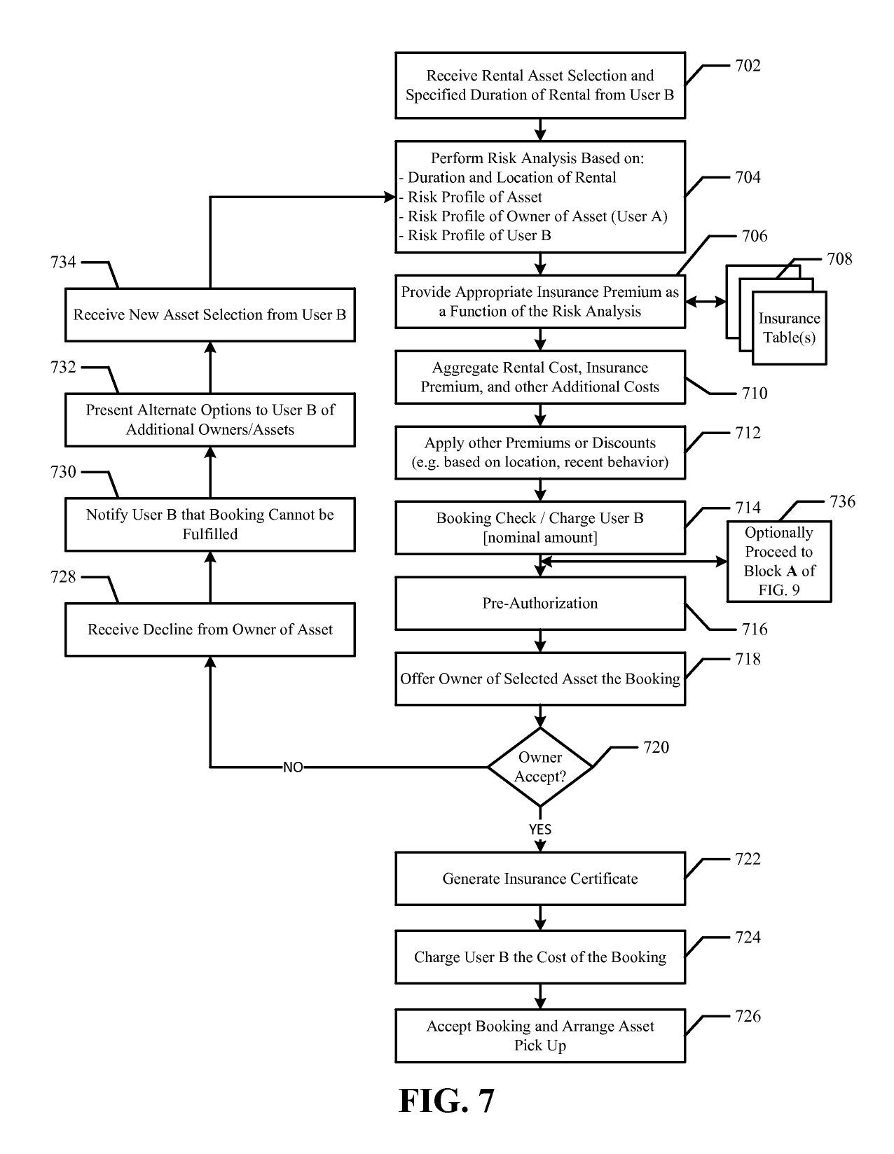

A flow diagram of processing a booking for an asset is described with reference to FIGS. 7-9. As illustrated in FIG. 7, the computing device(s) 102 receives 702 an asset selection and a specified time and duration of rental from the User B. A risk analysis is performed 704 for the transaction, based on the risk profile of the User B, the risk profile of the asset, the risk profile of the asset owner (User A), and the duration and location of the proposed rental transaction. For example, the overall transaction risk may be determined as a function of asset risk (object value, age etc) times booking risk (duration, location etc) times member risk (user profiles, transaction history, ages etc), which provides a risk weighting. This number is then mapped against a premium table to convert this value into a cost. It should be appreciated that the risk weighting is not static and can fluctuate over time.

An appropriate insurance premium for a custom insurance policy for specific the transaction is determined as a function of the result(s) of the risk analysis 706. In determining the insurance premium, the computing device(s) 102 may consult one or more price tables or insurance tables 708 and determine the insurance premium based on the prices of the similar insurance policies in the price tables. The risks and costs behind the insurance premium can be displayed to the users involved in the transaction or to the administrators of the computing device(s) 102 only.

The insurance premium, rental costs, and any additional costs are aggregated 710, and any other premiums or discounts (for example, based on location or good/bad behavior) are applied 712 resulting in a final cost for the rental of the asset. After the final cost is determined, the computing device(s) 102 may perform a booking check and charge a nominal amount to the User B 714, and pre-authorize 716 the User B based upon the nominal amount. The User A (owner of the asset) is then offered the booking 718 via the interfaced to the User A or asset owner. The User A may also have the option to accept or decline the booking 720 before it completes. Again, this stage is optional (based on the transaction type). An owner can pre-define these limitations (or the platform can) meaning that those who satisfy these risk parameters can instantly book the asset without needing owner input.

If the owner has the capacity/capability to approve any bookings, accepting the booking, such as via an acceptance via the user interface, an insurance certificate for the custom insurance plan can be generated 722, and the User B is charged the balance of the final cost of the rental 724. The booking is accepted and a time and place for exchange of the asset is arranged 726. The custom insurance policy is generated in real-time to cover the specific users for the specific asset for the duration specified in the specific transaction. For example, the custom insurance policy would cover User A's asset being insured for use by User B for a fixed duration. The custom insurance policy may be provided to all the users involved in the transaction along with a transaction confirmation. The applicable insurance certificate may be provided to one or more of the users by email, or other delivery method. Additionally, the custom insurance policy generation may be defined as contingent on completion of payment.

If the asset owner has the capability/capacity to approve any bookings and chooses to decline the booking, the computing device(s) 102 receives a decline message from the User A 728, and notifies the User B that the booking cannot be fulfilled 730. In this instance, the User B may be presented with alternative options of other assets and owners of those assets 732. The User B may then select a new asset 734 and the booking process proceeds much as described hereinbefore. Upon selection of the new asset, the steps of blocks 704-714, 718 and 720 may be repeated to modify the risk analysis with the new owner and asset, generate a new custom insurance policy, modify the final cost, and offer the new owner the booking. If the new owner accepts the booking, the process proceeds through the steps of blocks 722-726. However, if the new asset owner declines the booking, the process of presenting alternative options to the User B may be repeated again.

Referring still to FIG. 7, optionally, the computing device(s) 102 may present alternative options to the User B prior to pre-authorizing the User B 736.

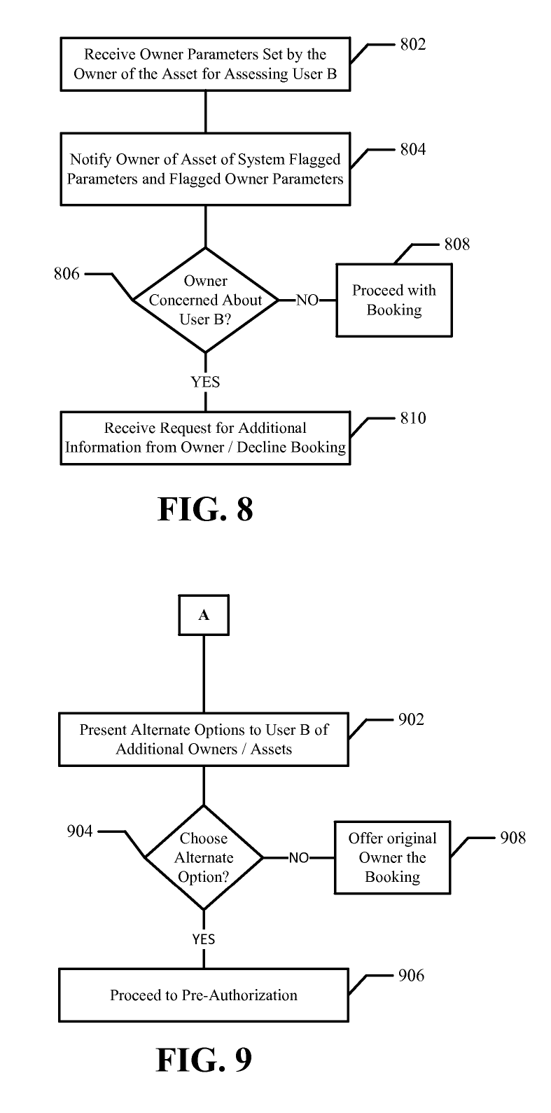

In an embodiment, the step of offering the owner of the asset (User A) the booking may include notifying the User A of flagged parameters relating to the User B (i.e. the renter). Referring to FIG. 8, the computing device(s) 102 may automatically flag certain parameters that may be of interest to User A and may also allow the owner of the asset (User A) to set a number of parameters to assess the individual seeking to rent the User A's asset, for example, the parameters may include the age of the User B, the experience of the User B, the location of the User B, what the User B plans to use User A's asset for, and other parameters that may be defined by the asset owner or system administrator and/or selected as preferences by the User A. As illustrated, the computing device(s) 102 may receive specified parameters from the User A for assessing the User B 802. The User A is notified of flagged parameters automatically flagged by the computing device(s) 102 and flagged parameters specified by the User A 804. This provides the User A with the option to decline (or accept) the booking if the User A is concerned about User B 806 based on the flagged parameters. If the User A is not concerned, the booking proceeds 808. However, if the User A is concerned, the User A may send a request for additional information about the User B, which is received by the computing device(s) 102, or simply decline the booking 810.

Referring now to FIG. 9, the computing device(s) 102 may present alternative options of additional assets and owners to the User B, for which the User B qualifies 902. This allows the User B to choose one of the alternative options prior to booking with the originally selected asset and owner (User A) 904. If the User B selects one of the alternative options, the process proceeds to the preauthorization step 716 and continues through the process with the newly selected asset and owner 906. Alternatively, if the User B declines the alternative options, the process proceeds to the preauthorization step 716 and continues through the process with the originally selected asset and owner (User A) 908.

Although, the devices, systems, and methods are described in connection with vehicle rentals, the devices, systems, and methods can be used in connection with transactions and rentals of other assets, for example, including, but not limited to, motorcycles, watercrafts, aviation vehicles, real estate properties, tools, tractors, heavy machinery, lawnmowers, recreational vehicles (e.g. snow mobiles, all-terrain vehicles, etc.), recreational equipment (e.g. bicycles, skis, snowboards, etc.), furniture, party tents, and other assets, and combinations thereof.

The devices, systems, and methods disclosed herein can include, and may be implemented, within a number of different devices and computer systems, including, for example, general-purpose computing systems, server-client computing systems, mainframe computing systems, a cloud computing infrastructure, telephone computing systems, laptop computers, desktop computers, smart phones, cellular phones, personal digital assistants (PDAs), tablet computers, and other mobile devices. The devices and computing systems may have one or more databases and other storage apparatuses, servers, and additional components, for example, processors, modems, terminals and displays, computer-readable media, algorithms, modules, and other computer-related components. The devices and computer systems and/or computing infrastructures are configured, programmed, and adapted to perform the functions and processes of the devices, systems, and methods as disclosed herein.

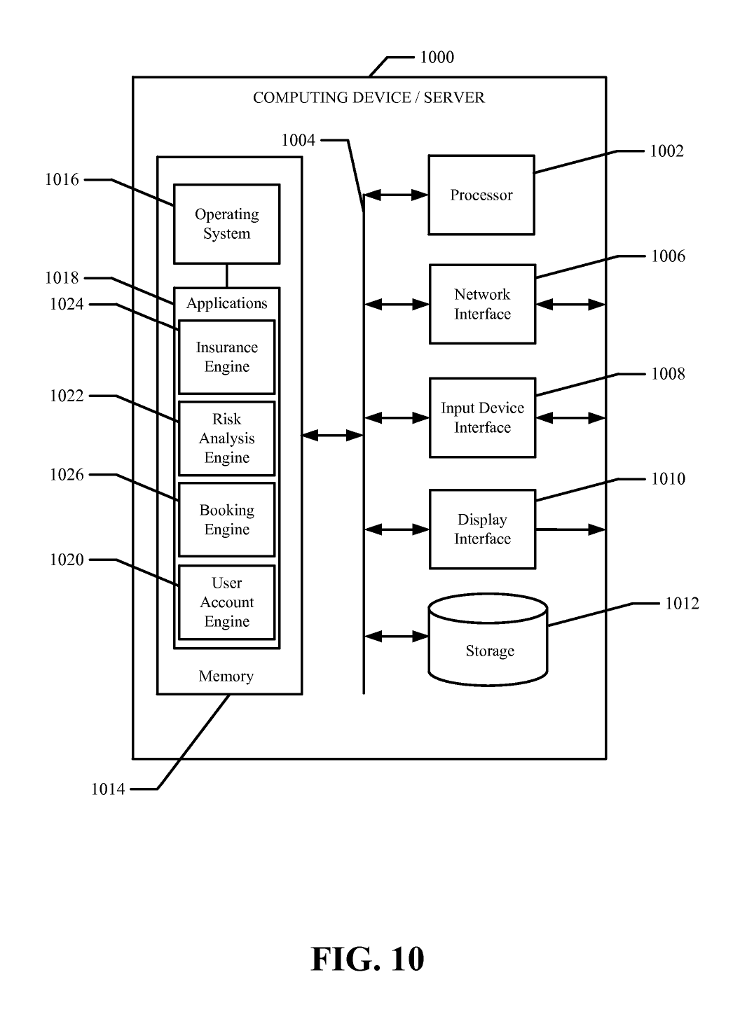

In an illustrative embodiment, the devices, systems, and methods are implemented in a computing device 1000 (such as the computing device(s) 102) or server. A block diagram of a computing device 1000 of the present disclosure is described with reference to FIG. 10. The computing device 1000 may include a processor 1002 in communication with a variety of other components over a system bus 1004 or through a direct connection. These other components may include, for example, a network interface 1006, an input device interface 1008, a display/user interface 1010, and a storage database 1012.

The processor 1002 may be configured to operate in accordance with programming instructions stored in a memory 1014. The memory 1014 generally comprises RAM, ROM, and/or other memory. Thus, in addition to storage in read/write memory (RAM), programming instructions may also be embodied in read-only format, such as those found in ROM or other permanent memory. The memory 1014 may store an operating system 1016 for controlling the operation of the computing device 1000. The operating system may be a general purpose operating system such as a Microsoft Windows operating system, a UNIX operating system, a Linux operating system, or an operating system specifically written for and tailored to the computing device 1000.

The memory 1014 may also store user-executable applications 1018, or programs, for conducting various functions on the computing device 1000. In an illustrative embodiment, the application 1018 in memory 1014, may include a user account engine 1020, a risk analysis engine 1022, an insurance engine 1024, and a booking engine 1026. These applications 1018 may be configured according to aspects of the present disclosure to perform risk based analyses, generate insurance contracts and policies, and book asset transactions and store information on the storage database 1012.

The user account engine 1020 may request information from users or prompt users for data, for example, the User A and/or User B data described above. The user account engine 1020 may validate the data received from the users by looking-up information in third party databases. The risk analysis engine 1022 may determine and assess the qualification, eligibility, and/or the risk profiles of the users and assets, and perform the risk analysis. The insurance engine 1024 may price and generate the custom insurance policies for the transactions. The booking engine 1026 may accept and process the users through the booking processes described above.

As appreciated by those skilled in the art, the network interface 1006 enables the computing device 1000 to communicate data, control signals, data requests, and other information with other resources including computers, data sources, storage devices, and the like, on a computer network such as the Internet. The network interface 1006 may be configured to communicate via wired or wireless connections. As one skilled in the art should appreciate, the computing device 1000 may obtain, receive, and transmit data from another computer, a storage device, a client device, or other source via the computer network.

The input device interface 1008, sometimes also embodied as an input/output interface, enables the computing device 1000 to obtain data input from a variety of devices including, but not limited to, a digital pen, a touch screen, a keyboard, a mouse, a scanner, a speaker or microphone, and the like. In addition, the display interface 1010 may be used for outputting display information to a computer user. Typically, the display information is output by the display interface 1010 via a display device (e.g., a monitor or similar device). While not illustrated, one skilled in the art should appreciate that a display device may be incorporated as an integral element within a computing device 1000 or may be separate therefrom.

Communications between components in the devices, systems, and methods disclosed herein may be unidirectional or bidirectional electronic communication through a wired or wireless configuration or network. For example, one component may be wired or networked wirelessly, directly or indirectly, through a third party intermediary, over the Internet, or otherwise with another component to enable communication between the components. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type.

The embodiments disclosed herein may be performed in different forms of software, firmware, and/or hardware. The embodiments disclosed herein may be performed on a single device or may be performed on multiple devices. For example, program modules including one or more components described herein may be located in different devices and may each perform one or more aspects of the present disclosure. As used in this disclosure, the term “a” or “one” may include one or more items unless specifically stated otherwise. Further, the phrase “based on” is intended to mean “based at least in part on” unless specifically stated otherwise. Moreover, unless specifically stated any use of the terms first, second, etc. do not denote any order or importance, but rather the terms first, second, etc. are merely used to distinguish one element from another.

The client device may be a personal computer, a laptop computer, a cellular phone, a personal digital assistant (PDA), a tablet computer, and other desktop or mobile device of the type. The embodiments disclosed herein may be implemented as a computer implemented method, a system, a device, or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid state memory, flash drive, removable disk, and/or other media.

Although the devices, systems, and methods have been described and illustrated in connection with certain embodiments, many variations and modifications will be evident to those skilled in the art and may be made without departing from the spirit and scope of the disclosure. The discourse is thus not to be limited to the precise details of methodology or construction set forth above as such variations and modification are intended to be included within the scope of the disclosure.

What is claimed is:

1. A method of processing a peer-to-peer transaction, comprising:
receiving, by a computing device, a request from a first user for a transaction including an asset of a second user;
performing, by the computing device, a risk analysis associated with the transaction based on one or more of a risk profile of the first user, a risk profile of the asset, and a risk profile of the second user;
determining, by a computing device, an insurance premium for a custom insurance policy tailored to the transaction; and
generating, by a computing device, a certificate for the custom insurance.

2. The method of claim 1 wherein in said step of receiving, by a computing device, a request from a first user for a transaction including an asset of a second user, the asset is a vehicle, the second user is the owner of the vehicle and the first user is seeking to rent or lease the vehicle.

3. The method of claim 1 wherein the second user submits information about the asset that is used in the step of performing the risk analysis.

4. The method of claim 2 wherein the second user submits information about a vehicle, including at least one of a license plate number of the vehicle and a postal code where the vehicle is located.

5. The method of claim 3 further including the step of validating the second user submitted information by searching one or more third party databases.

6. The method of claim 2 further comprising the step of providing a suggested rent or lease price for the vehicle.

7. The method of claim 1 wherein the asset of the second user is a vehicle and the method further includes the step of creating a risk profile for the vehicle and the second user based on data about the vehicle and data about the second user, respectively.

8. The method of claim 1 wherein said step of generating, by a computing device, a certificate for the custom insurance policy is performed in response to the second user accepting the transaction.
